(19) United States
(12) Patent Application Publication
(10) Pub. No.: US 2016/0073442 A1
(43) Pub. Date: Mar. 10, 2016

(54) MOBILITY HANDLING FOR DUAL CONNECTIVITY

(71) Applicant: NOKIA TECHNOLOGIES OY, Espoo (FI)

(72) Inventors: Jussi-Pekka KOSKINEN, Oulu (FI); Jarkko Tuomo KOSKELA, Oulu (FI); Jorma Johannes KAIKKONEN, Oulu (FI); Lars DALSGAARD, OULU (FI); Esa Mikael MALKAMÄKI, Espoo (FI)

(21) Appl. No.: 14/888,177

(22) PCT Filed: May 9, 2014
(86) PCT No.: PCT/FI2014/050337

§ 371 Date: Oct. 30, 2015

Related U.S. Application Data
(60) Provisional application No. 61/822,248, filed on May 10, 2013.

(51) Int. Cl. H04W 76/02

(52) U.S. Cl. CPC H04W 76/025; H04W 76/028

(57) ABSTRACT

Methods and apparatus, including computer program products, are provided for dual connectivity. In one aspect there is provided a method. The method may include detecting, at a user equipment configured for dual connectivity to a secondary cell and a primary cell, a radio link failure with the secondary cell; and reporting, in response to the detected radio link failure, an indication of the radio link failure with the secondary cell, wherein the user equipment maintains connectivity with the primary cell despite the radio link failure with the secondary cell. Related apparatus, systems, methods, and articles are also described.

### FIELD

The subject matter described herein relates to wireless communications and, in particular, mobility.

### BACKGROUND

Carrier aggregation allows increased bandwidth and, as such, increased data rates to a user equipment by aggregating carriers. For example, a user equipment may be allocated a primary carrier serving a primary cell (PCell) and one or more secondary carriers serving corresponding secondary cells (SCells). These carriers may be continuous within the same frequency band, non-contiguous within a given frequency band, or non-contiguous among frequency bands.

### SUMMARY

Methods and apparatus, including computer program products, are provided for dual connectivity.

In some example embodiments, there may be provided a method that includes detecting, at a user equipment configured for dual connectivity to a secondary cell and a primary cell, a radio link failure with the secondary cell; and reporting, in response to the detected radio link failure, an indication of the radio link failure with the secondary cell, wherein the user equipment maintains connectivity with the primary cell despite the radio link failure with the secondary cell.

In some variations, one or more of the features disclosed herein including the following features can optionally be included in any feasible combination. The method may further include inhibiting, in response to the detected radio link failure with the secondary cell, a connection re-establishment procedure with the secondary cell. The user equipment may receive configuration information to at least inhibit the connection re-establishment procedure with the secondary cell in response to the radio link failure with the secondary cell. The user equipment may receive configuration information to at least trigger another connection re-establishment procedure, when another radio link failure is detected with the primary cell. The user equipment may trigger the another connection re-establishment procedure, when the user equipment detects the another radio link failure with the primary cell. The connection re-establishment procedure and the another connection re-establishment procedure may each comprise a radio resource control connection re-establishment procedure. The primary cell may include a macrocell, and the secondary cell may include a small cell.

In some example embodiments, there may be provided a method that includes sending, by a network node, configuration information to a user equipment configured for dual connectivity to a secondary cell and a primary cell, wherein the configuration information includes information to declare a radio link failure with a secondary cell while maintaining connectivity to the primary cell and information to inhibit triggering, in response to the radio link failure, a connection re-establishment procedure; and receiving, at the network node serving the primary cell, a report in response to the radio link failure, wherein the report includes an indication of the radio link failure with the secondary cell.

Moreover, in some example embodiments, there may be provided a method. The method may include receiving, at a user equipment, configuration information indicating one or more times for the user equipment to switch between a first carrier associated with a primary cell and a second carrier associated with a secondary cell; accessing, during a time indicated by the received configuration information, the first carrier to at least monitor the first carrier; and accessing, during another time indicated by the received configuration information, the second carrier to at least receive user-plane data.

In some variations, one or more of the features disclosed herein including the following features can optionally be included in any feasible combination. The first carrier and the second carriers may comprise dual connectivity carriers. The first carrier and the second carrier may provide a separation between user-plane data and mobility signaling.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts an example of a system configured for dual connectivity, in accordance with some exemplary embodiments;

FIG. 2 depicts an example process for dual connectivity, in accordance with some exemplary embodiments;

FIG. 3 depicts an example of a user equipment, in accordance with some exemplary embodiments; and

FIG. 4 depicts an example of a base station, in accordance with some exemplary embodiments.

Like labels are used to refer to same or similar items in the drawings.

### DETAILED DESCRIPTION

In some example embodiments, the user equipment is assumed to be connected to two different network nodes (for example, a macrocell evolved Node B (eNB) base station and a small cell eNB base station). When this is the case, the user equipment may not be simultaneously receiving/transmitting from/to these different eNBs. Thus, the user equipment may be connected to one eNB at a time and switching between these two eNBs according to a time division multiplexing (TDM) pattern, which may be predetermined (configured) or may vary according to data/control transmission needs.

In some example embodiments, mobility may be based on the macro frequency layer but small (or secondary) cell (SCell) changes may not trigger handover and related signaling including S1 signaling in a wireless device, such as a user equipment. For example, a radio link failure (RLF) may only be declared if a connection to a macro base station, such as an evolved node B (eNB) base station, serving the macrocell or primary cell (PCell) is lost. But if a connection to a base station, such as a wireless access point or an eNB base station serving a small cell or secondary cell (SCell) is lost, the user equipment may not, in some example embodiments, declare a RLF and initiate a radio resource control (RRC) re-establishment. Instead, the user equipment may, in some example embodiments, continue to listen to the macro base station serving the macrocell/PCell at one or more predetermined times. As such, the user equipment may be reachable on the PCell served by the macro base station even when the connection via the SCell is lost. Thus, there is no need for declaring RLF in the small cell.

Furthermore, the macro base station serving the PCell may, in some example embodiments, need to know whether the user equipment is able to monitor/listen for base stations serving SCells, and this information may be provided to the macro base station serving the PCell by the user equipment via regular measurement reporting (for example, RRC signaling), channel quality indication (CQI) reporting (for example, uplink control information (UCI) on a primary uplink control channel (PUCCH) or on a primary uplink shared channel (PUSCH)), and/or a specific message indicating SCell loss.

In some example embodiments, the connection between the user equipment and the macro eNB base station/PCell may be implemented as a single RRC connection. For example, RRC message(s) may be carried by links via the macro base station serving the PCell, the base station serving the SCell, or a combination of both.

Moreover, the user equipment may, in some example embodiments, be configured to have one or more silent periods in the transmission/reception. These silent periods may represent measurement gaps, gaps associated with cell-specific discontinuous reception (DRX), or some other time domain multiplexing pattern defined in the SCell serving the user equipment. During available gaps/silent periods, the user equipment may measure a macrocell/PCell and/or monitor the physical downlink control channel (PDCCH) of the macrocell/PCell to follow/monitor signaling (or scheduling for user data). For example, the user equipment may monitor the macro eNB base station every 40 or 80 milliseconds (ms), although longer or shorter times may be used as well, for mobility and related information, commands, and/or measurements.

In some example embodiments, a user equipment may be configured to only receive/transmit via a single frequency layer at any given time, so the user equipment may not be capable of simultaneously operating with multiple carrier aggregation (CA) carrier frequencies or be configured to operate using only a single carrier (and thus a single radio frequency transceiver or chain). For example, a PCell carrier may be provided by a macro eNB base station (which may provide, for example, a macro layer/mobility layer), and the SCell may be provided by a small cell, such as a pico cell base station and the like (which may provide, for example, a small or pico layer). However, the user equipment disclosed herein may, in some example embodiments, be configured to, at any given time, access and/or monitor only one type of cell, such as a PCell and/or a SCell at any given time. In this configuration, the user equipment may be considered to be in a TDM configuration mode, so that the user equipment may switch between cells and thus only access/monitor one cell/base station connection at any given time. Moreover, this switching may be performed based on a TDM configuration using the silent periods associated with a given cell. In addition, the user equipment may, in some example embodiments, be configured with a TDM configuration to switch to a first cell, such as a PCell, for mobility and other related signaling operations, but use either the PCell or the SCell for data, such as user-plane data and its associated scheduling.

Although some of the examples above describe a single carrier frequency user equipment not capable of simultaneously operating with multiple carrier aggregation frequencies, the subject matter disclosed herein may, in some example embodiments, may be used with any device/user equipment including those capable of operating with multiple frequencies (which may enable power savings and the like). For example, a user equipment configured to operate using a plurality of CA carriers, such as 3 or more carrier aggregation carriers, may be configured so that a subset of those carrier frequencies are operated in accordance with the TDM scheduling mode disclosed herein.

In some example embodiments, the subject matter disclosed may thus enable a user equipment to operate using two connections, such as a first connection to a PCell and another to a SCell, but with separation of the mobility layer signaling and user data serving layer. To illustrate, the user equipment may be active (for example, making measurements, monitoring the PDCCH, and the like) on the PCell/base station connection only during times configured by the network (for example, in accordance with a TDM configuration, such as silent periods/measurement gaps/and the like available at the SCell during which the user equipment is not scheduled in SCell/small cell layer or based on the connected mode-DRX configuration from the PCell).

In some example embodiments, the user equipment may be configured by the network via the PCell with measurement configurations. In some example embodiments, radio link monitoring (RLM), problem detection, and RLF evaluation may also be configured by the network via the PCell. As such, an actual RLF may only be declared when the connection to mobility layer/PCell is lost.

In some example embodiments, TDM scheduled periods (or gaps) may be assigned to, or configured at, the user equipment based on a current measurement gap pattern available with respect to the SCell or based on a PCell DRX synchronized with SCell.

In some example embodiments, the user equipment may be configured to have a first cell (for example, SCell) user-plane data connection, so continuous connection/reception via the mobility layer provided by a macro base station/PCell may not be required. Instead, the user equipment may thus rely on the TDM based approach disclosed herein to access the macro base station/PCell from time to time. For example, the user equipment may be coupled to the user-plane via the SCell, and based on a TDM configuration (for example, the silent periods or gaps in transmission at the SCell) switch to perform measurement and/or monitoring of the PCell/mobility layer. Moreover, DRX at the PCell may also provide silent periods during which the user equipment can monitor, measure, and/or be scheduled. The network may then, depending on the architecture, choose whether to schedule the user equipment from the PCell or SCell.

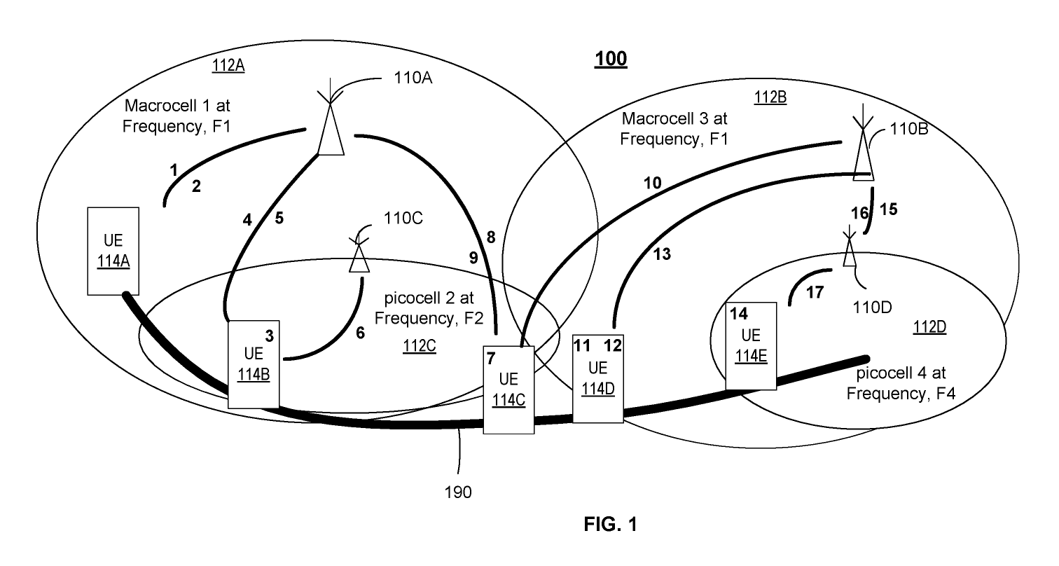

FIG. 1 depicts an example of a system 100 including a user equipment 114A-E as it travels along path 190, in accordance with some example embodiments. System 100 includes two macrocells 112A-B served by base stations, such as evolved node B (eNB) base stations 110A-B, and small cells 112C-D served by base stations 110C-D, in accordance with some example embodiments. Moreover, the macrocells 112A-B may, in some example embodiments, be configured as primary carriers, or primary cells (PCells) for carrier aggregation, and small cells 112C-D may be configured as secondary cells (SCells) for carrier aggregation (CA) or for dual connectivity.

At 1, the network including eNB base station 110A may transmit to user equipment 114A a message, such as an RRCConnectionReconfiguration message, in accordance with some example embodiments. This message may be sent via a first (macro) cell 112A and may configure a second (small) cell 112C as a secondary cell (SCell) or assisting cell. Moreover, this message may include configuration information including one or more times when silent periods or gaps, also referred to as a TDM pattern, are available for use for switching carrier frequencies in order to access, monitor, measure, and/or the like among PCell and SCell connections. This TDM pattern may represent one or more gaps, such as a measurement gap or a DRX gap, with respect to SCell 112C. The user equipment 114A may, during these gaps, measure PCell 112A/eNB base station 110A and/or monitor PDCCH from PCell 112A at different times (for example, using only a single RX/TX frequency chain at UE 114A). In some instances, the DRX configuration for the PCell 112A may have to be updated in order to avoid conflicts/collisions with the DRX configuration of SCell 112C.

The message sent by the network at 1 (and thus received by user equipment 114A) may further include configuration information including which measurement reporting events to report on. For example, the network may configure user equipment 114A to trigger event A4 (for example, Neighbor becomes better than threshold) with respect to SCell's 112C frequency and event A3 (for example, Neighbor becomes offset better than PCell) for PCell 112A.

Event reporting criteria may refer to measurement reporting events, such as Events A1, A2, and the like described in 3rd Generation Partnership Project, Technical Specification Group Radio Access Network, Evolved Universal Terrestrial Radio Access (E-UTRA) Radio Resource Control (RRC), Protocol specification (Release 8 or later release) TS 36.331 (herein after TS 36.331); 3rd Generation Partnership Project, Technical Specification Group Radio Access Network, Evolved Universal Terrestrial Radio Access (E-UTRA), Requirements for support of radio resource management (Release 8 or later release) 3GPP TS 36.133 (hereinafter TS 36.133), and/or any other standards as well. Although other types of events may be configured and used as well.

Although the previous example refers to an RRCConnectionReconfiguration message, other types of message may be used as well. Moreover, the configuration information may include other information as well including configurations to handle more than two carrier frequencies, more than two cells, and the like.

At 2, user equipment 114A may transmit via macrocell/PCell 112A a message, such as an RRCConnectionReconfigurationComplete message, to confirm completion of the dual connectivity TDM configuration provided at 1, in accordance with some example embodiments.

At 3, user equipment 114B may move to the coverage area of small cell/SCell 112C, and the radio conditions of SCell 112C may be measured so that the radio conditions are considered suitable for use by user equipment 1148 when transmitting/receiving data, in accordance with some example embodiments.

At 4, the user equipment 114B may transmit a message, such as a MeasurementReport message, via PCell/macrocell 112A to report an event, such as event A4 for SCell 112C, in accordance with some example embodiments. This message may be transmitted when SCell 112C is detected and considered as usable for carrying data transmissions. Additionally or alternatively, user equipment 114B may report the SCell 112C change via some other message, such as a lower layer media access control and/or physical layer signaling (for example, CQI reporting and the like).

At 5, the network including eNB base station 110A may activate SCell 112C for user equipment 114B by sending an activation media access control (MAC) control element (CE) to the user equipment 114B via macrocell eNB 110A, in accordance with some example embodiments. Alternatively or additionally, SCell 112C may already be active when the SCell change is reported by the user equipment 114B, so explicit an activation command sent from the network to the user equipment may not be required.

At 6, user equipment 114B may receive and/or transmit data via SCell 112C, in accordance with some example embodiments. The user equipment 114B may also monitor PCell 112A (and its frequency) according to TDM configuration provided at 1. For example, the user equipment 114B may use a single connection to receive and/or transmit user-plane data via SCell 112C, and switch to monitor/measure the frequency associated with PCell 112A. This switching may be performed every 40 milliseconds or so in accordance with the TDM configuration provided at 1, although other times and TDM configuration's may be used as well. At this point, user equipment 114B may be scheduled to access both cells 112A and C at different times in accordance with the TDM configuration provided at 1.

At 7, radio conditions of cells 112A and 112B may begin to change, such that user equipment 114C may trigger an event, in accordance with some example embodiments. For example, the event A3 triggering condition may be satisfied at user equipment 114C for the macrocell cell/PCell 112B provided by eNB base station 110B.

At 8, user equipment 114C may transmit a message, such as a MeasurementReport message, to PCell 112A/eNB base station 110A to report event A3 being triggered with respect to PCell 112B, in accordance with some example embodiments. Alternatively or additionally, user equipment 114C may send the message including the measurement report to SCell 112C/base station 110C.

At 9, the network including base station 110A may transmit a message, such as an RRCConnectionReconfiguration message, including mobility control information from PCell 112A, in accordance with some example embodiments. This message may represent a command to user equipment 114C/D to perform a handover to PCell 112B (which may be on same or different frequency as PCell 112A). The configuration of SCell 112C may remain the same after the handover assuming that SCell 112C is still usable. However, the TDM pattern provided at 1 may need to be updated or changed in such a way that there is no conflict at PCell 112A and PCell 112B. Alternatively or additionally, SCell 112C may be de-configured (or, for example, released) if there is no dual connectivity available between PCell 112B and SCell 112C. Moreover, the network may send the RRCConnectionReconfiguration via an SCell as well.

At 10, user equipment 114C may transmit a message, such as an RRCConnectionReconfigurationComplete message, via PCell 112B to confirm completion of the handover to PCell 112B, in accordance with some example embodiments.

At 11, radio conditions of SCell 112C may begin to deteriorate, so the user equipment 114D may no longer be able to receive/transmit via SCell 112C. In accordance with some example embodiments, user equipment 114D may not, at 12, declare a RLF with respect to SCell 112C despite the deterioration at 11, but instead continue to monitor cell 112B configured as a PCell.

At 13, user equipment 114D may, in some example embodiments, indicate that the connection to SCell 112C is lost by sending a message, such as a MeasurementReport message indicating a triggering of event A2 (for example, serving becomes worse than threshold). Alternatively or additionally, user equipment 114D may indicate the lost SCell 112C connection via lower-layer MAC or PHY signaling. For example, CQI and/or channel state information (CSI) reporting may be used.

At 14, user equipment 114E may, in some example embodiments, enter the coverage area of cell 112D, which in this example is a small/pico cell on the same layer as SCell 112C. The carrier frequency of cell 112D may be the same as the carrier frequency of cell 112C or the carrier frequencies may be different. Moreover, the radio conditions of cell 112D may begin to be such that cell 112D is suitable for use (for example, data transmission/reception) by user equipment 114E.

At 15, user equipment 114E may, in some example embodiments, transmit to base station 110B a message, such as a MeasurementReport message, including a report of the triggering of event A4 for cell 112D. Alternatively or additionally, user equipment 114E may report an SCell change via some other message, for example, lower-layer MAC or PHY signaling.

At 16, the network including eNB base station 110B may, in some example embodiments, activate cell/SCell 112D by sending a MAC CE to the user equipment. Alternatively or additionally, SCell 112D may be active when the SCell change is reported by the user equipment 114E, so an explicit activation command from the network may not be necessary.

At 17, user equipment 114E may, in some example embodiments, receive and transmit data on via SCell 112D and/or measure/monitor (for example, the PDCCH of) PCell 112B/eNB 110B (and its frequency) according to a TDM configuration (for example, the measurement gap configuration providing for monitoring every 40 milliseconds, although other times may be provided as well).

The TDM configurations including measurement gap configurations (see, e.g., 3GPP TS 36.331) for mobility layer/PCell may be determined based on the requirements defined in 3GPP TS 36.133, although other configurations may be used as well. To enable longer scheduling occasions, as measurement gaps are likely to provide only few transmission time intervals, alternative measurement gap patterns may be defined with longer gap durations (for example, from 6 ms to 10 ms and so forth). Furthermore, connected mode DRX operation may, as defined in 3GPP TS 36.321, be configured from the mobility layer/PCell perspective to reconcile the scheduling occasions. The reconciled configuration may be done by the macrocell/PCell, so that the user equipment can be informed of the dual connectivity connected-DRX configuration provided by the mobility layer/PCell to small cell layer/SCell. In addition, the SCell may apply scheduling gaps accordingly to enable the user equipment to receive via the PCell according to the connected-DRX configuration. In addition, radio link problem (RLP) detection may also be determined for DRX and different DRX cycle lengths.

Before providing additional description regarding the dual connectivity mobility disclosed herein, the following provides additional details regarding example implementations of some of the devices.

The base stations 110A-D may, in some example embodiments, be implemented as an evolved Node B (eNB) type base station consistent with standards, including the Long Term Evolution (LTE) standards, such as 3GPP TS 36.201, Evolved Universal Terrestrial Radio Access (E-UTRA); Long Term Evolution (LTE) physical layer; General description, 3GPP TS 36.211, Evolved Universal Terrestrial Radio Access (E-UTRA); Physical channels and modulation, 3GPP TS 36.212, Evolved Universal Terrestrial Radio Access (E-UTRA); Multiplexing and channel coding, 3GPP TS 36.213, Evolved Universal Terrestrial Radio Access (E-UTRA); Physical layer procedures, 3GPP TS 36.214, Evolved Universal Terrestrial Radio Access (E-UTRA); Physical layer—Measurements, and any subsequent additions or revisions to these and other 3GPP series of standards (collectively referred to as LTE standards). The base station may also be configured as a femtocell base station, home evolved node B base station, a picocell base station, a WiFi access point, and/or a wireless access point configured in accordance with other radio access technologies as well. Moreover, the base stations may be configured to provide carrier aggregation to a given user equipment.

The user equipment, such as user equipment 114A-E, may be implemented as a mobile device and/or a stationary device. The user equipment are often referred to as, for example, mobile stations, mobile units, subscriber stations, wireless terminals, tablets, smart phones, or the like. A user equipment may be implemented as, for example, a wireless handheld device, a wireless plug-in accessory, a wireless transceiver configured in a stationary device, a wireless transceiver configured in a mobile device and/or the like. In some cases, user equipment may include a processor, a computer-readable storage medium (e.g., memory, storage, and the like), a radio interface(s), and/or a user interface. In some example embodiments, the user equipment may be configured to receive a TDM configuration defining when to switch between an SCell and a PCell and to separate mobility and user-plane connections.

Although FIG. 1 depicts a certain quantity of devices and a certain configuration, other quantities and configurations may be used as well.

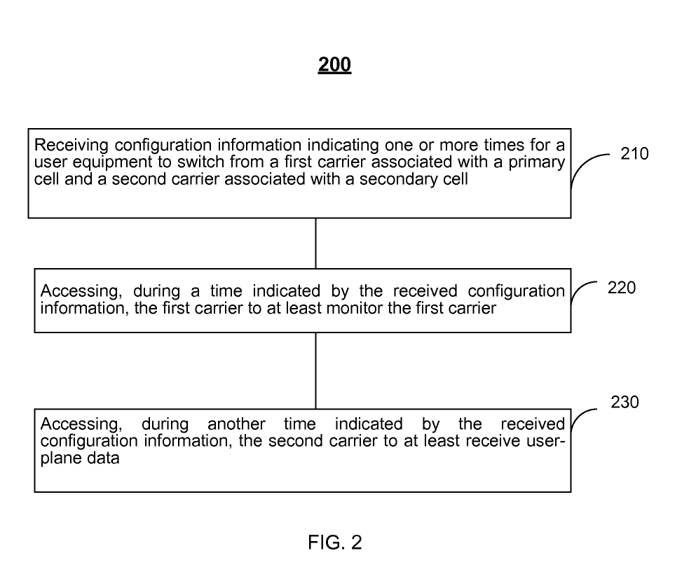

FIG. 2 depicts a process for mobility handling via dual connections, in accordance with some example embodiments. The description of FIG. 2 also refers to FIG. 1.

At 210, a user equipment may, in some example embodiments, receive configuration information to enable single frequency operation among dual connection, such as via PCells and SCells. For example, the network, such as eNB base station 110A, may provide configuration information to user equipment 114B. This configuration information may represent a TDM configuration for the user equipment, so the user equipment knows when to switch it's receiver to monitor, measure, and/or otherwise access another cell/base station carrier frequency. To illustrate further, the equipment 114A-B may receive configuration information indicating that it should couple to SCell 112C for user-plane data transmission/reception, but switch during silent periods at SCell 112C to monitor, measure, and/or otherwise access PCell 112A for mobility purposes. The configuration information may also define a TDM configuration defining when to switch, such as at 40 or 80 millisecond intervals, although other times and TDM configurations may be used as well. Moreover, the configuration information may configure the user equipment to only declare a RLF, and re-establish an RRC connection when there is a failure in the PCell 112A (or cell 112B), but not the SCell 112C (or cell 112D). Furthermore, the configuration information may configure the user equipment to use the PCell to provide a mobility layer and signaling and only declare the RLF only when there is a loss of the PCell, and user plane communications may occur via either PCell or SCell, so loss of the SCell would not result in RLF and thus RRC connection reestablishment.

At 220, the user equipment may, in some example embodiments, access a first cell, such as SCell 112C, to obtain user-plane data, and switch in accordance with the configuration provided at 210, to another cell, such as a PCell 112A. For example, the user equipment 114B may have a user-plane connection at carrier frequency, f2, with base station 110C/SCell 112C, and switch based on the configuration provided at 210 to carrier frequency f1 of base station 110A/PCell 112A. This switching may be performed during silent periods at SCell 112C, such as during measurement gaps, gaps due to discontinuous reception (DRX) at SCell 112C, and/or the like. When the user equipment switches to carrier frequency f1, the user equipment may make measurements on the PCell 112A, monitor the physical downlink control channel (PDCCH) of 112A for signaling or scheduling information, and/or the like. Furthermore, the user equipment is able to maintain two, separate connections (for example, for mobility and for use data) accessed in a TDM manner as disclosed herein.

At 230, the user equipment may, in some example embodiments, switch back to the first cell, in accordance with the configuration provided at 210. For example, the configuration information provided at 210 may define a TDM configuration pattern also defining how when the user equipment 114B should switch from monitoring/measuring at carrier frequency f1 of base station 110A/PCell 112A to carrier frequency, f2, at base station 110C/SCell 112C.

The process 200 may, in some example embodiments, enable a user equipment to use a single frequency receiver-transmitter chain to access multiple carrier aggregation carriers, such as one or more PCells and SCells, while maintaining mobility.

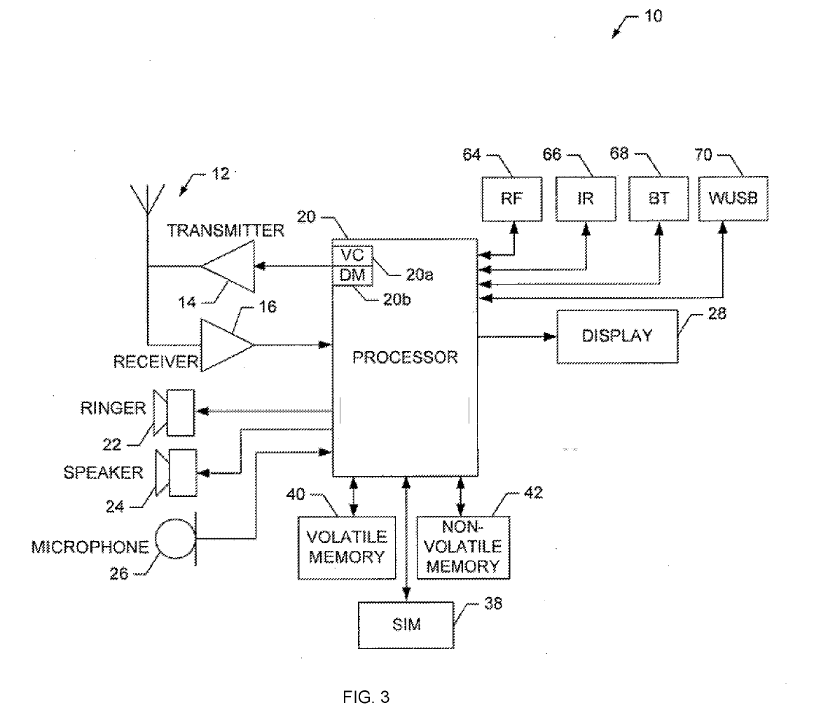

FIG. 3 illustrates a block diagram of an apparatus 10, which can be configured as user equipment in accordance with some example embodiments.

The apparatus 10 may include at least one antenna 12 in communication with a transmitter 14 and a receiver 16. Alternatively transmit and receive antennas may be separate.

The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise processor 20 may be configured to control other elements of apparatus 10 by effecting control signaling via electrical leads connecting processor 20 to the other elements, such as for example, a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 3 as a single processor, in some example embodiments the processor 20 may comprise a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as for example, Institute of Electrical and Electronics Engineers (IEEE) 802.11, 802.16, and/or the like. In addition, these signals may include speech data, user generated data, user requested data, and/or the like.

The apparatus 10 may be capable of operating with one or more air interface standards, communication protocols, modulation types, access types, and/or the like. For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as for example, Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as for example, Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as for example, LTE Advanced and/or the like as well as similar wireless communication protocols that may be subsequently developed. Further, the apparatus may be capable of operating in accordance with carrier aggregation.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as for example, a web browser. The connectivity program may allow the apparatus 10 to transmit and receive web content, such as for example, location-based content, according to a protocol, such as for example, wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as for example, the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as for example, a keypad 30 (which can be a virtual keyboard presented on display 28 or an externally coupled keyboard) and/or other input devices.

As shown in FIG. 3, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as for example, an infrared (IR) transceiver 66, a Bluetooth (BT) transceiver 68 operating using Bluetooth wireless technology, a wireless universal serial bus (USB) transceiver 70, and/or the like. The Bluetooth transceiver 68 may be capable of operating according to low power or ultra-low power Bluetooth technology, for example, Wibree, radio standards. In this regard, the apparatus 10 and, in particular, the short-range transceiver may be capable of transmitting data to and/or receiving data from electronic devices within a proximity of the apparatus, such as for example, within 10 meters, for example. The apparatus 10 including the WiFi or wireless local area networking modem may also be capable of transmitting and/or receiving data from electronic devices according to various wireless networking techniques, including 6LoWpan, Wi-Fi, Wi-Fi low power, WLAN techniques such as for example, IEEE 802.11 techniques, IEEE 802.15 techniques, IEEE 802.16 techniques, and/or the like.

The apparatus 10 may comprise memory, such as for example, a subscriber identity module (SIM) 38, a removable user identity module (R-UIM), and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing functions of the user equipment/mobile terminal. The memories may comprise an identifier, such as for example, an international mobile equipment identification (IMEI) code, capable of uniquely identifying apparatus 10. The functions may include one or more of the operations disclosed herein with respect to the user equipment, such as for example, the functions disclosed at FIGS. 1 and 2 (for example, receiving, at a user equipment, configuration information to declare a radio link failure when there is at least one of deterioration or loss in connectivity via a first carrier associated with a primary cell but not declare the radio link failure when there is at least one of deterioration or loss in connectivity via a second carrier associated with a secondary cell, reporting, by the user equipment, the at least one of deterioration or loss in connectivity of the second carrier associated with the secondary cell, switching between PCell and SCells based on a TDM configuration, and/or the like as disclosed herein). The memories may comprise an identifier, such as for example, an international mobile equipment identification (IMEI) code, capable of uniquely identifying apparatus 10. In the example embodiment, the processor 20 may be configured using computer code stored at memory 40 and/or 42 to enable the user equipment to switch between PCell and SCells based on a TDM configuration and/or any other function associated with the user equipment or apparatus disclosed herein.

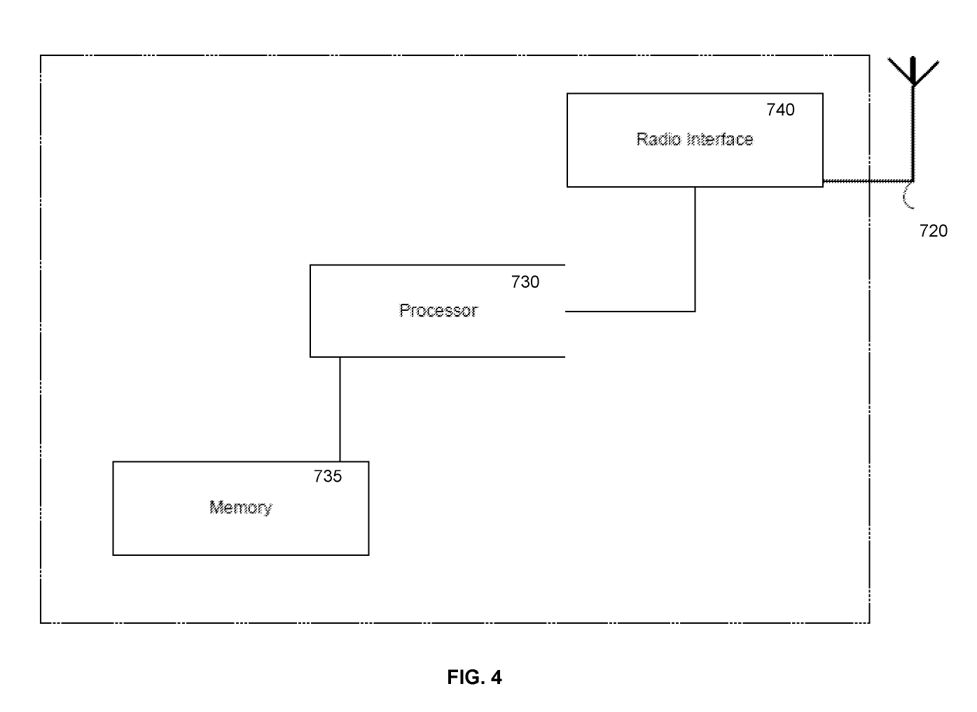

FIG. 4 depicts an example implementation of a network node, such as a base station, access point, and/or any other type of node. The network node may include one or more antennas 720 configured to transmit via a downlink and configured to receive uplinks via the antenna(s) 720. The network node may further include a plurality of radio interfaces 740 coupled to the antenna 720. The radio interfaces may correspond one or more of the following: Long Term Evolution (LTE, or E-UTRAN), Third Generation (3G, UTRAN, or high speed packet access (HSPA)), Global System for Mobile communications (GSM), wireless local area network (WLAN) technology, such as for example 802.11 WiFi and/or the like, Bluetooth, Bluetooth low energy (BT-LE), near field communications (NFC), and any other radio technologies. The radio interface 740 may further include other components, such as filters, converters (for example, digital-to-analog converters and/or the like), mappers, a Fast Fourier Transform (FFT) module, and/or the like, to generate symbols for a transmission via one or more downlinks and to receive symbols (for example, via an uplink). The network node may further include one or more processors, such as processor 730, for controlling the network node and for accessing and executing program code stored in memory 735. In some example embodiments, memory 735 includes code, which when executed by at least one processor causes one or more of the operations described herein with respect to a base station (for example, send configuration information to declare a radio link failure when there is at least one of deterioration or loss in connectivity via a first carrier associated with a primary cell but not declare the radio link failure when there is at least one of deterioration or loss in connectivity via a second carrier associated with a secondary cell; and receive, at the apparatus, a report from a user equipment, wherein the report indicates the at least one of deterioration or loss in connectivity of the second carrier associated with the secondary cell, provide a TDM configuration for switching between PCell and SCell, and/or the like as disclosed herein).

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as for example, a computer or data processor, with examples depicted at FIGS. 3 and 4. A computer-readable medium may comprise a non-transitory computer-readable storage medium that may be any media that can contain or store the instructions for use by or in connection with an instruction execution system, apparatus, or device, such as for example, a computer. Moreover, some of the embodiments disclosed herein include computer programs configured to cause methods as disclosed herein (see, for example, FIG. 1, process 200, and/or the like).

Without in any way limiting the scope, interpretation, or application of the claims appearing below, a technical effect of one or more of the example embodiments disclosed herein may include optimized RLF and/or providing dual connectivity even when the user equipment is only capable of a single RX/TX chain.

If desired, the different functions discussed herein may be performed in a different order and/or concurrently with each other. Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of the present invention as defined in the appended claims. Other embodiments may be within the scope of the following claims. The term “based on” includes “based on at least.”

1-30. (canceled)

31. A method comprising:
detecting, at a user equipment configured for dual connectivity to a secondary cell and a primary cell, a radio link failure with the secondary cell; and
reporting, in response to the detected radio link failure, an indication of the radio link failure with the secondary cell, wherein the user equipment maintains connectivity with the primary cell despite the radio link failure with the secondary cell.

32. The method of claim 31 further comprising:
inhibiting, in response to the detected radio link failure with the secondary cell, a connection re-establishment procedure with the secondary cell.

33. The method of claim 31 further comprising:
receiving, at the user equipment, configuration information to at least inhibit the connection re-establishment procedure with the secondary cell in response to the radio link failure with the secondary cell.

34. The method of claim 31 further comprising:
receiving, at the user equipment, configuration information to at least trigger another connection re-establishment procedure, when another radio link failure is detected with the primary cell.

35. The method of claim 34 further comprising:
triggering, at the user equipment, the another connection re-establishment procedure, when the user equipment detects the another radio link failure with the primary cell.

36. The method of claim 31, wherein the connection re-establishment procedure and the another connection re-establishment procedure each comprise a radio resource control connection re-establishment procedure.

37. The method of claim 31, wherein the primary cell comprises a macrocell, and wherein the secondary cell comprises a small cell.

38. The method of claim 31, wherein the primary cell is served by at least one base station, and wherein the secondary cell is served by at least one other base station.

39. An apparatus comprising:
at least one processor; and
at least one memory including computer program code, the at least one memory and the computer program code configured to, with the at least one processor, cause the apparatus to perform at least the following:
detect, at the apparatus configured for dual connectivity to a secondary cell and a primary cell, a radio link failure with the secondary cell; and
reporting, in response to the detected radio link failure, an indication of the radio link failure with the secondary cell, wherein the apparatus maintains connectivity with the primary cell despite the radio link failure with the secondary cell.

40. The apparatus of claim 39, wherein the apparatus is further configured to at least inhibit in response to the detected radio link failure with the secondary cell, a connection re-establishment procedure with the secondary cell.

41. The apparatus of claim 39, wherein the apparatus is further configured to at least receive configuration information to at least inhibit the connection re-establishment procedure with the secondary cell in response to the radio link failure with the secondary cell.

42. The apparatus of claim 39, wherein the apparatus is further configured to at least receive configuration information to at least trigger another connection re-establishment procedure, when another radio link failure is detected with the primary cell.

43. The apparatus of claim 42, wherein the apparatus is further configured to at least trigger the another connection re-establishment procedure, when the user equipment detects the another radio link failure with the primary cell.

44. The apparatus of claim 39, wherein the connection re-establishment procedure and the another connection re-establishment procedure each comprise a radio resource control connection re-establishment procedure.

45. The apparatus of claim 39, wherein the primary cell comprises a macrocell, and wherein the secondary cell comprises a small cell.

46. The apparatus of claim 39, wherein the primary cell is served by at least one base station, and wherein the secondary cell is served by at least one other base station.

47. An apparatus serving a primary cell comprising:
at least one processor; and
at least one memory including computer program code, the at least one memory and the computer program code configured to, with the at least one processor, cause the apparatus to perform at least the following:
send, by the apparatus, configuration information to a user equipment configured for dual connectivity to a secondary cell and the primary cell, wherein the configuration information includes information to declare a radio link failure with the secondary cell while maintaining connectivity to the primary cell and information to inhibit triggering, in response to the radio link failure, a connection re-establishment procedure; and
receive, at the apparatus, a report in response to the radio link failure, wherein the report includes an indication of the radio link failure with the secondary cell.

48. The apparatus of claim 47, wherein the apparatus comprises a base station.
